(19) United States
(12) Patent Application Publication
(10) Pub. No.: US 2015/0183580 A1
(43) Pub. Date: Jul. 2, 2015

(54) Traceable Fluid Delivery System

(71) Applicant: Willie Simmons, JR., North Augusta, SC (US)

(72) Inventor: Willie Simmons, JR., North Augusta, SC (US)

(21) Appl. No.: 14/584,704

(22) Filed: Dec. 29, 2014

Related U.S. Application Data
(60) Provisional application No. 61/921,892, filed on Dec. 30, 2013.

(51) Int. Cl. B65D 90/48; F16L 9/12

(52) U.S. Cl. CPC B65D 90/48; F16L 9/12

(57) ABSTRACT

A traceable fluid delivery system includes a plurality of spaced apart metallic identification members coupled to a non-metallic pipe member. A plurality of traceable water pipes may be coupled together and buried to create an underground water or sewage system. A metal detector may be used to locate and mark the location of the metallic identification members. By marking the location of each metallic identification member, the location of the traceable water pipe can be ascertained so that damage to the underground water or sewage system can be avoided when digging in the area. The traceable delivery system may include a storage tank coupled to respective metallic identification members.

### REFERENCE TO RELATED APPLICATIONS

This application claims the benefit of provisional patent application U.S. Ser. No. 61/921,892 filed Dec. 30, 2013 titled Traceable Water Pipe.

### BACKGROUND OF THE INVENTION

This invention relates generally to construction and plumbing devices and, more particularly, to a traceable fluid delivery system water pipe that includes non-metallic pipe and non-metallic storage tank having a plurality of spaced apart metallic identification members coupled thereto.

Plastic pipes, such as polyvinyl chloride (PVC) and Acrylonitrile Butadiene Styrene (ABS), are often used in underground water and sewage systems, including sprinkler systems and lateral fields. Plastic pipes are ideal for these underground applications due to their relatively low cost, relatively high durability, and long term duration.

Underground water and sewage systems utilizing plastic pipes and storage tanks often last for years without needing to be maintained or replaced. Such longevity, however, often means that the exact location of buried plastic pipes may be long forgotten when a future project requires digging in the vicinity of an underground water or sewage system. If a digger is unable to ascertain the location of the buried plastic pipes, the digger may accidently hit the plastic pipes. When digging with machinery such as a backhoe or a trencher, the digger may even break the buried plastic pipes.

Although plastic water and sewage pipes are relatively inexpensive, the cost of fixing a broken water or sewage pipe can far exceed the cost of the damaged pipe itself. Additionally, a broken water or sewage pipe can create a mess in the newly dug hole or trench and may lead to a major delay in completion of a project. Consequently, it is highly desirable to avoid hitting a buried water or sewage pipe while digging.

To avoid hitting underground utilities while digging, a digger can arrange for the underground utilities to be marked. The utility company sends a locator to the dig site and the locator places intermittent markings on the surface of the ground to indicate the approximate location of buried utility lines, utility pipes, and/or utility cables. By following the intermittent markings, a digger can ascertain the approximate location of buried utilities. By ascertaining the approximate location of the buried utilities, a digger is less likely to hit the buried utilities while digging.

Often, a simple metal detector can be used to locate buried utilities and other buried metallic objects. Currently, however, there is no equivalent detector for buried non-metallic objects, such as plastic piping. Instead, to ascertain the location of a non-metallic pipe with a simple metal detector, metallic objects must be buried with the non-metallic pipe. If the metal objects are spaced apart along a length of the non-metallic pipe or along portions of a non-metallic tank, a person could use a simple metal detector to locate and mark the location of each metallic object. By marking the location of each metal object, a digger can ascertain the location of the non-metallic pipe or tank. Therefore, it would be desirable to have a traceable non-metallic fluid delivery system with a plurality of spaced apart metallic identification members coupled to a non-metallic pipe member.

### SUMMARY OF THE INVENTION

A traceable non-metallic fluid delivery system according to the present invention includes a plurality of spaced apart metallic identification members, such as strap members metallic straps or strips coupled to a non-metallic pipe member or storage tank, respectively. The non-metallic pipe member may be coupled to other traceable water pipes and tanks to create a traceable underground water or sewage system. A simple metal detector may be used to locate and mark the location of metallic strap members. By marking the location of the metallic identification members, a digger can ascertain the location of the traceable water pipes.

Therefore, a general object of this invention is to provide a traceable fluid delivery system that can be located after it has been buried.

Another object of this invention is to provide a traceable fluid delivery system, as aforesaid, that includes metallic strap members that can be detected by a simple metal detector.

Yet another object of this invention is to provide a traceable fluid delivery system, as aforesaid, that is easy to use and inexpensive to fabricate.

Other objects and advantages of the present invention will become apparent from the following description taken in connection with the accompanying drawings, wherein is set forth by way of illustration and example, embodiments of this invention

### BRIEF DESCRIPTION OF THE DRAWINGS

FIG. 1 is a perspective view of a traceable water pipe according to a preferred embodiment of the present invention;

FIG. 2 is a side view of the water pipe as in FIG. 1;

FIG. 3 is a sectional view taken along line 3-3 of FIG. 1;

FIG. 4 is a sectional view taken along line 4-4 of FIG. 1;

FIG. 5 is an exploded view of the water pipe as in FIG. 1;

FIG. 6 is a perspective view of a storage tank according to on embodiment of the present invention;

FIG. 7 is an exploded view of the storage tank as in FIG. 6;

FIG. 8 is a perspective view of a storage tank according to another embodiment of the present invention; and

FIG. 9 is an exploded view of the storage tank as in FIG. 8.

### DESCRIPTION OF THE PREFERRED EMBODIMENT

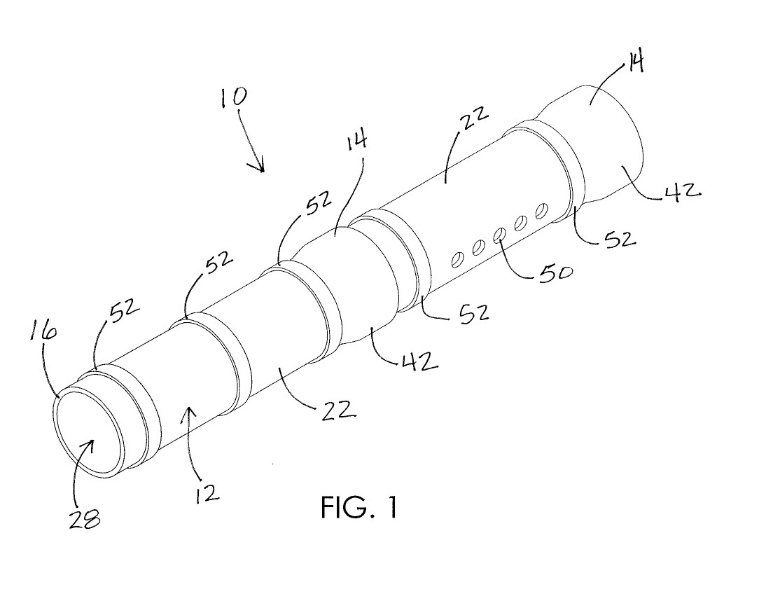

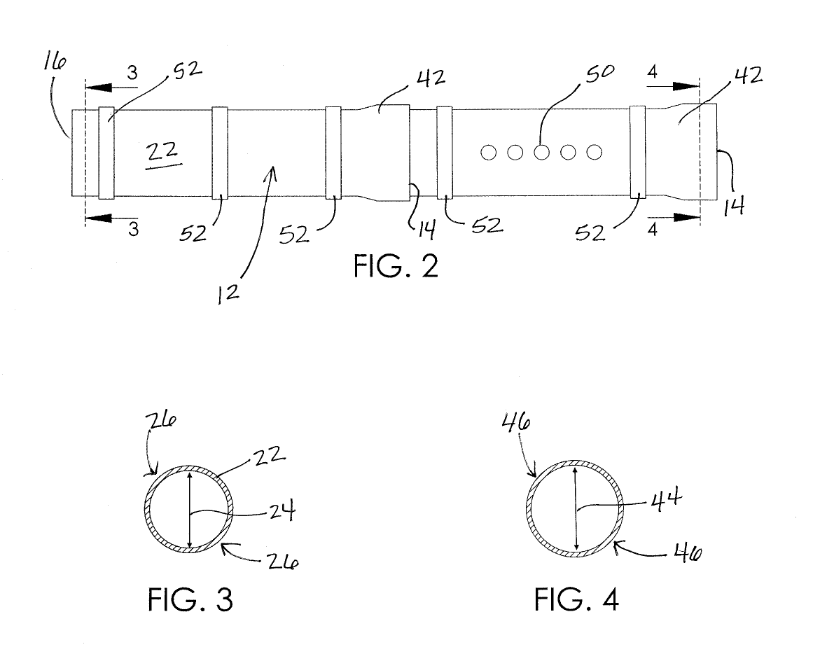

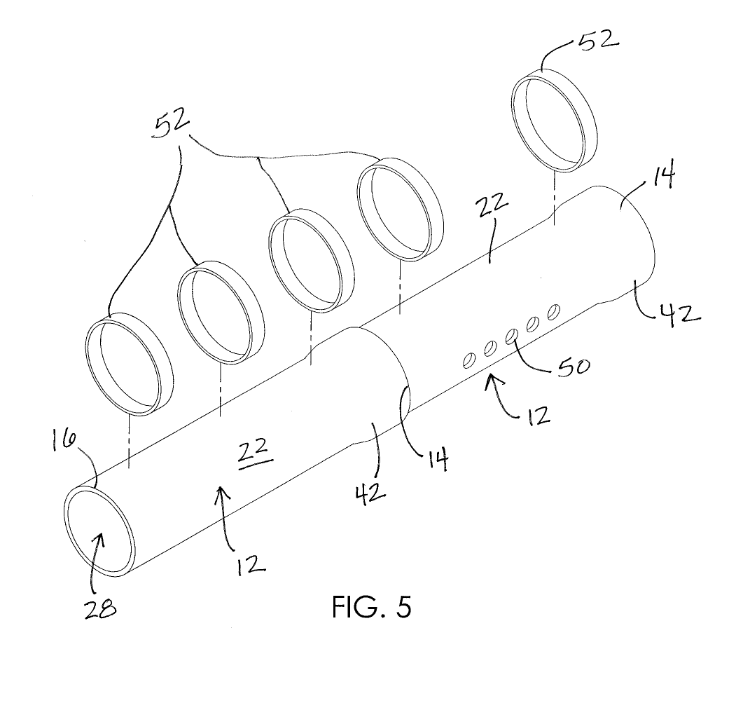

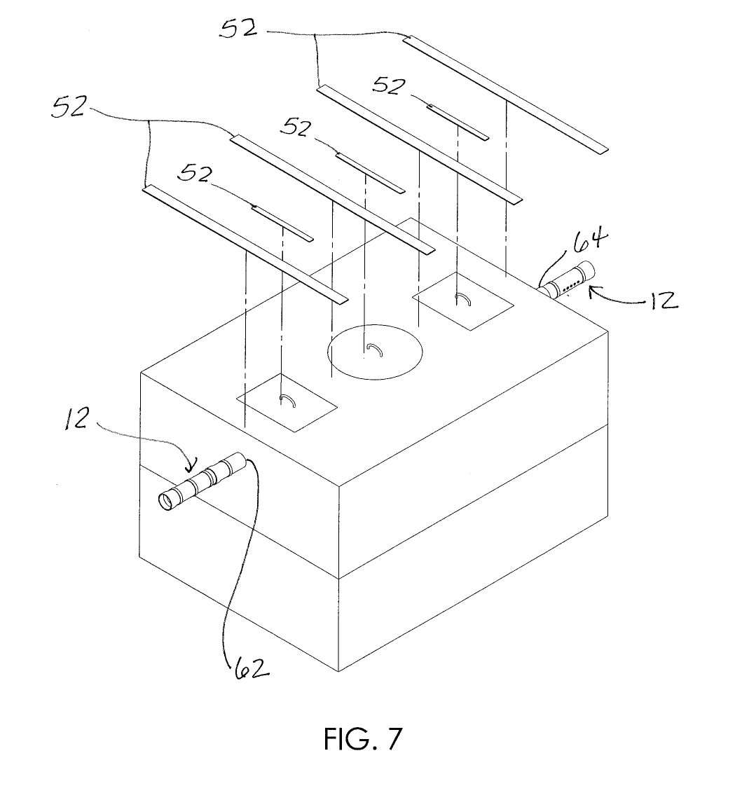

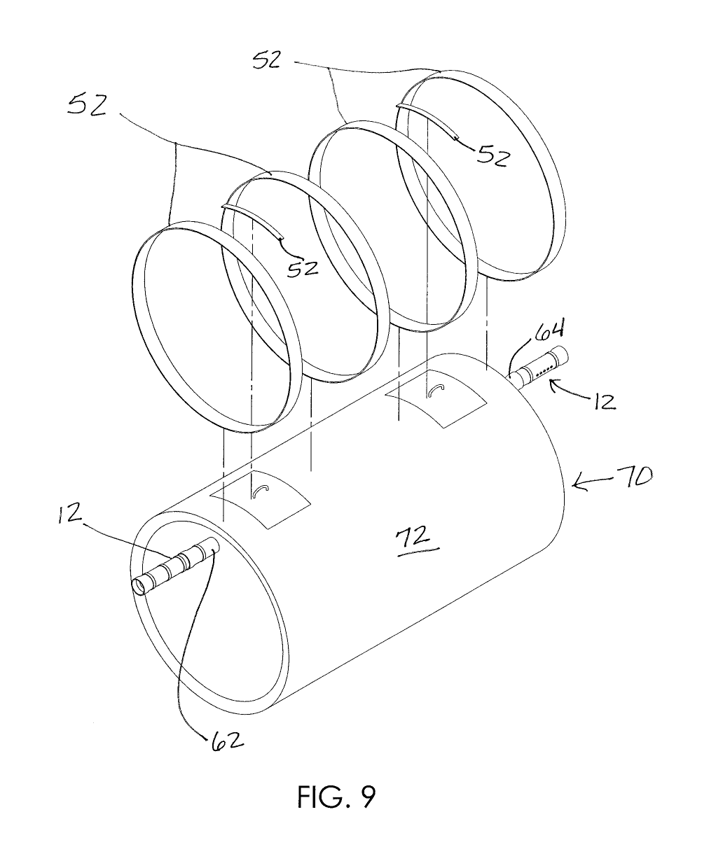

A traceable fluid delivery system according to a preferred embodiment of the present invention will now be described in detail with reference to FIGS. 1 to 9 of the accompanying drawings. The traceable fluid delivery system 10 includes a non-metallic pipe member 12 and a plurality of spaced apart metallic identification members 52 coupled to the non-metallic pipe member 12 and non-metallic storage tank 60. In one embodiment, the fluid delivery system 10 includes a non-metallic storage tank 60 to which associated metallic identification members 52 may be coupled.

The non-metallic pipe member 12 has opposed first 14 and second 16 ends. Accordingly, the non-metallic pipe member 12 defines a pipe length. The non-metallic pipe member 12 includes a wall member 22. In one embodiment, the wall member 22 has a continuous and tubular configuration. The wall member 22 defines an internal pipe diameter 24 and an external pipe diameter 26. Accordingly, the wall member defines an interior area 28 through which fluid, such as water, natural gas, or the like may flow. The wall member 22 may further define a plurality of holes 50 spaced apart along the pipe length.

The non-metallic pipe member 12 may also include a flange member 42 coupled to the wall member 22 at the first end 14 of the non-metallic pipe member 12. The flange member 42 defines an internal flange diameter 44 and an external flange diameter 46. The internal flange diameter 44 of a first non-metallic pipe member 12 may be substantially the same as the external pipe diameter 26 of a second non-metallic pipe member 12 such that the flange member 42 of the first non-metallic pipe member 12 may selectively receive the second end 16 of the second non-metallic pipe member 12.

In one embodiment, each metallic identification member 52 may be a strap having a circuitous configuration complementary to the circuitous or cylindrical configuration of the pipe member 12. Accordingly, each strap extends completely about the exterior surface of the pipe member 12 (FIG. 1). Metallic identification members 52 may be evenly spaced apart along the pipe length and bonded around the circumference of the non-metallic pipe member 12 (FIG. 1). Alternatively, each metallic strap member 52 may be imbedded within the wall member 22 and/or the flange member 42. In another embodiment (not shown), each metallic identification member 52 may be coupled to the exterior surface of the pipe member 12 although may not extend completely thereabout. In one embodiment, the metallic identification members may extend longitudinally between opposed ends of the pipe member 12.

Preferably, the wall member 22 of the non-metallic pipe member 12 is fabricated from a non-metallic material, such as polyvinyl chloride (PVC) or Acrylonitrile Butadiene Styrene (ABS). The flange member 42 may also be fabricated from a non-metallic material. In one embodiment, the wall member 22 and the flange member 42 may be fabricated as a single piece of non-metallic material. Each metallic strap member 52 may be fabricated from a corrosion-resistant metal, such as stainless steel.

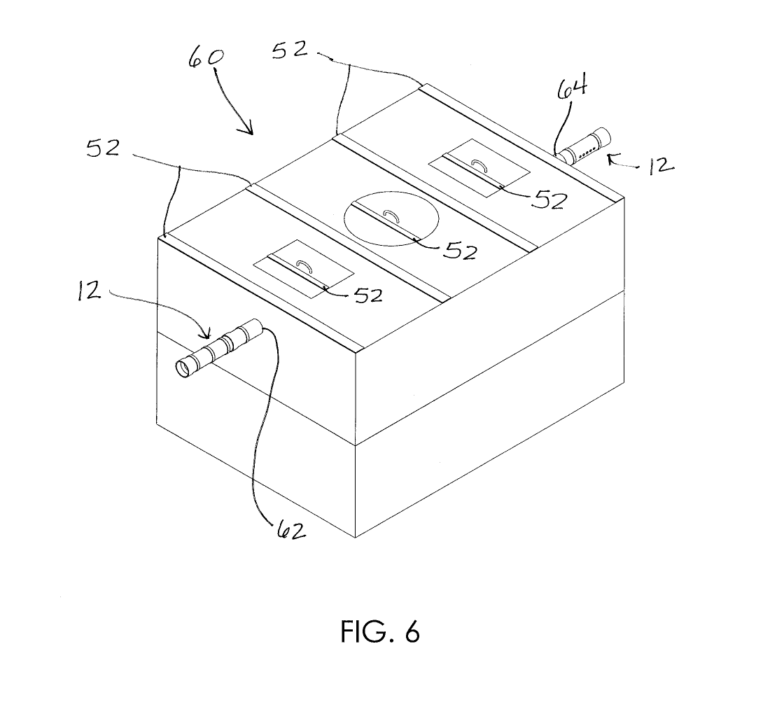

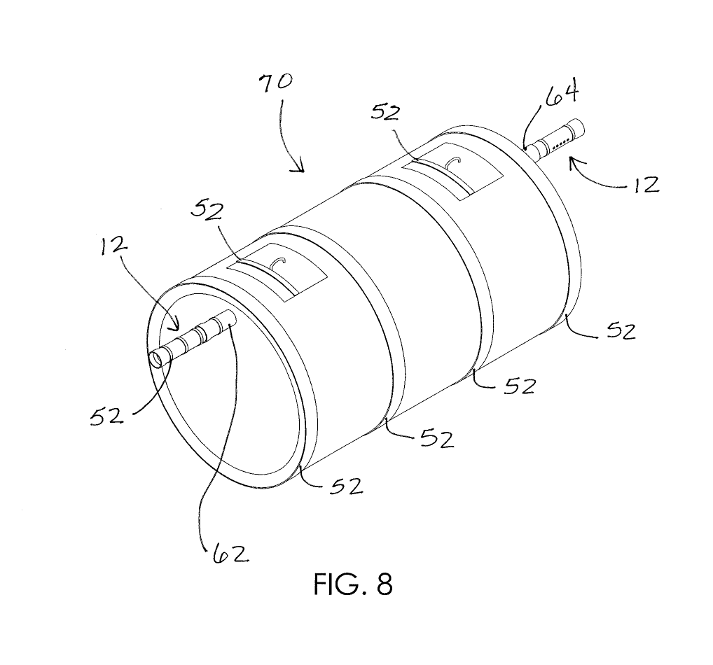

As described above, the traceable fluid delivery 10 includes at least one fluid storage tank 60. Septic fluid storage tanks are often constructed of cement or plastic, making their location below ground a difficulty unless metal is coupled to the tank. The storage tank 60 may be a sewage reservoir having inlet 62 and outlet 64 pipes, the pipes being configured in the manner of the plurality of non-metallic pipe members 12 described above. The storage tank 60 may have a rectangular configuration having a bottom, upstanding side walls, and a top wall (FIG. 6). In an embodiment, a storage tank 70 may have a cylindrical or ovular configuration having a continuous side wall 72 (FIG. 8). In either embodiment, respective magnetic identification members 52 may be coupled to an exterior surface of a respective top or side wall. The magnetic identification members 52 may be positioned in a configuration spaced apart from one another (FIG. 8) or in a continuous manner (not shown). In either arrangement, respective identification members may be arranged along a peripheral edge or edges such that the shape and extent of the storage tank 60 may be determined by use of a metal detector above a ground surface beneath which the storage tank is buried. In addition, an identification member 52 may be positioned on one or more access lids that provide access to the internal space of the tank (FIG. 6). This is especially important in the instance of a cylindrical tank in which an access lid may not be oriented in a completely upright configuration, i.e. the lid is off center or the like.

It is understood that in some septic and sewage systems, a chamber (not shown) may be positioned downstream from the septic tank 60 and connected thereto with pipe members 12. Specifically, a leaching chamber is a wastewater treatment system consisting of trenches or beds, together with one or more distribution pipes or open-bottomed plastic chambers, installed in appropriate soils. These chambers receive wastewater flow from a septic tank or other treatment device and transmit it into soil for final treatment and disposal. A typical leaching chamber is 5 feet in length and may include about 10 ribs. With application to the present invention, an identification member 52 may be coupled to one or more ribs, such as the center rib, such that the position of a leaching chamber may be determined from above ground using a metal detector in the manner described above.

In use, a plurality of traceable water pipes 10 may be coupled together and buried to form an underground water or sewage system. Each metallic identification member 52 in the underground water or sewage system may be located by a metal detector. By locating each metallic identification member 52, the location of each non-metallic pipe member 12 or storage tank 60 can be determined and the profile marked in paint on the ground surface. In this way, a person wishing to dig in the vicinity of the underground water or sewage system may avoid damaging the traceable fluid delivery system 10.

It is understood that while certain forms of this invention have been illustrated and described, it is not limited thereto except insofar as such limitations are included in the following claims and allowable functional equivalents thereof.

1. A traceable fluid delivery system for use in identifying a location of buried fluid delivery pipes and storage tanks, comprising:
at least one pipe constructed of a non-metallic material, said at least one pipe having a first end and a second end opposed from said first end so as to define a pipe length;
a plurality of metallic identification members, each identification member being constructed of a metallic material;
wherein said plurality of metallic identification members are coupled to said at least one pipe, each metallic identification member being spaced apart from an adjacent metallic identification member.

2. The traceable fluid delivery system as in claim 1, comprising:
a fluid storage tank constructed of a non-metallic material, said fluid storage tank having an exterior surface;
wherein said plurality of identification members are coupled to said exterior surface of said fluid storage tank.

3. The traceable fluid delivery system as in claim 2, wherein:
said exterior surface of said fluid storage tank includes a top wall and at least one side wall; and
said plurality of identification members are coupled to at least one of said top wall and said at least one side wall.

4. The traceable fluid delivery system as in claim 2, wherein said plurality of identification members extends completely along a periphery of said fluid storage tank.

5. The traceable fluid delivery system as in claim 2, wherein said plurality of identification members are spaced apart along said exterior surface of said at least one fluid storage tank.

6. The traceable fluid delivery system as in claim 1, wherein:
said at least one pipe includes a continuous side wall such that said at least one pipe has a generally tubular configuration;
each identification member is a strap having a circuitous configuration that extends completely about said side wall of said at least one pipe.

7. The traceable fluid delivery system as in claim 1, wherein said at least one pipe is constructed of polyvinyl chloride (PVC) or acrylonitrile butadiene (ABS) material.

8. The traceable fluid delivery system as in claim 2, wherein:
said at least one pipe includes a continuous side wall such that said at least one pipe has a generally tubular configuration;
each identification member is a strap having a circuitous configuration that extends completely about said side wall of said at least one pipe.

9. The traceable fluid delivery system as in claim 1, wherein:
said at least one pipe defines an internal pipe diameter and an external pipe diameter;
said at least one pipe includes a flange section at said first end defining an internal flange diameter and an external flange diameter; and
said internal flange diameter of one pipe is substantially equal to said external pipe diameter of another pipe such that the one pipe and the another pipe are selectively coupled together via said flange section.

10. A traceable fluid delivery system for use in identifying a location of buried fluid delivery pipes and storage tanks, comprising:
a pipe constructed of a non-metallic material, said pipe having a first end and a second end opposed from said first end so as to define a pipe length therebetween;
a fluid storage tank constructed of a non-metallic material, said fluid storage tank having an exterior surface; and
a plurality of metallic identification members, each identification member being constructed of a metallic material;
wherein respective metallic identification members are coupled to said pipe, each metallic identification member being spaced apart from an adjacent metallic identification member;
wherein respective identification members are coupled to said outer surface of said fluid storage tank.

11. The traceable fluid delivery system as in claim 10, wherein:
said pipe includes a continuous side wall such that said pipe has a generally tubular configuration; and
each identification member is a strap having a circuitous configuration that extends completely about said side wall of said pipe.

12. The traceable fluid delivery system as in claim 10, wherein said pipe is constructed of polyvinyl chloride (PVC) or acrylonitrile butadiene (ABS) material.

13. The traceable fluid delivery system as in claim 10, wherein:
said exterior surface of said fluid storage tank includes a top wall and at least one side wall; and
said plurality of identification members are coupled to at least one of said top wall and said at least one side wall.

14. The traceable fluid delivery system as in claim 10, wherein said plurality of identification members are spaced apart along said exterior surface of said fluid storage tank.

15. The traceable fluid delivery system as in claim 14, wherein:
said exterior surface of said fluid storage tank includes a top wall and at least one side wall; and
said plurality of identification members are coupled to at least one of said top wall and said at least one side wall.

16. The traceable fluid delivery system as in claim 10, wherein:
said pipe defines an internal pipe diameter and an external pipe diameter;
said at least one pipe includes a flange section at said first end defining an internal flange diameter and an external flange diameter; and
said internal flange diameter of one pipe is substantially equal to said external pipe diameter of another pipe such that the one pipe and the another pipe are selectively coupled together via said flange.
